(19) United States
(12) Patent Application Publication
(10) Pub. No.: US 2014/0374660 A1
(43) Pub. Date: Dec. 25, 2014

(54) Engine Chemical Reactor With Catalyst

(71) Applicant: Massachusetts Institute Of Technology, Cambridge, MA (US)

(72) Inventors: Leslie Bromberg, Sharon, MA (US); Alexander Sappok, Cambridge, MA (US); John G. Brisson, Rockport, MA (US); William H. Green, Belmont, MA (US)

(21) Appl. No.: 14/314,299

(22) Filed: Jun. 25, 2014

Related U.S. Application Data
(60) Provisional application No. 61/838,905, filed on Jun. 25, 2013.

(51) Int. Cl. C01B 3/26; F02B 23/00

(52) U.S. Cl. CPC C01B 3/26; F02B 23/00
USPC 252/373; 123/670; 422/162

(57) ABSTRACT

The use of porous materials in the dead space of reciprocating engines is described. The porous material can be used to condition the cylinder gases. In addition, the porous material may include a catalyst for driving chemical reactions. The catalytic process occurs on the porous material, not on the cylinder walls. The engine parameters (number of cycles, number of strokes per cycle, compression ratio, engine speed, cylinder volume, valves timing, gas composition, pressure and temperature) are adjusted to optimize gas compression or chemical reactor performance.

This application claims priority of U.S. Provisional Patent Application Ser. No. 61/838,905, filed Jun. 25, 2013, the disclosure of which is incorporated herein by reference in its entirety.

### BACKGROUND

Engines have been proposed as chemical reactors for applications other than power or motive. For example, the use of engines, running rich, for the reforming of natural gas or other light has been proposed. Engines have been proposed for the manufacturing of acetylene. Others have also proposed using engines for the onboard manufacturing of hydrogen rich gas.

All these reactors are homogeneous, that is, in the absence of a catalyst. Therefore, the use of catalytic chemistry in an engine may be beneficial.

### SUMMARY

The use of porous materials in the dead space of reciprocating engines is described. The porous material can be used to condition the cylinder gases. In addition, the porous material may include a catalyst for driving chemical reactions. The catalytic process occurs on the porous material, not on the cylinder walls. The engine parameters (number of cycles, number of strokes per cycle, compression ratio, engine speed, cylinder volume, valves timing, gas composition, pressure and temperature) are adjusted to optimize gas compression or chemical reactor performance.

According to a first main embodiment, an engine is disclosed. The engine comprises a cylinder comprising a top surface, a reciprocating piston and a porous material disposed between the piston and the top surface. In some embodiments, the porous material occupies at least 50% of the volume within the cylinder when the piston is in a top dead center position.

In any of these embodiments, the porous material may be disposed on the top surface of the cylinder. Alternatively, in any of these embodiments, the porous material may be disposed in a volume between the top surface and the piston. In yet other embodiments, the porous material may be disposed on the piston.

In any of these embodiments, the porous material may comprise a metallic foam. Alternatively, in any of the above embodiments, the porous material may comprise compressible elastic metal, ceramic or organic fibers. In any of the above embodiments, the porous material may comprise a honeycomb structure.

In any of these embodiments, a porosity of the porous material is between 30% and 98%.

In any of the above embodiments, the engine may further comprise a non-contact heating mechanism to control a temperature of the porous material.

In any of the above embodiments, the porous material in a first region of the cylinder has a different characteristic than the porous material in a second region. In a further embodiment, the characteristic is selected from the group consisting of porosity, pore density and material composition.

In a second main embodiment, a method of processing a gas at near-isothermal conditions is disclosed. This method comprises introducing a gas into a cylinder having a reciprocating piston and a porous material disposed in the cylinder between a top surface and the piston; and moving the piston in the cylinder to as to compress the gas, where the porous material controls the temperature of the gas during the compression.

In one further embodiment, the method further comprises controlling a temperature of the porous material. In one further embodiment, the porous material is disposed on a top surface of the cylinder defined by a cylinder head, and the porous material is cooled by coolant flowing in the cylinder head. In an alternate further embodiment, the porous material is cooled by a heat pipe that conducts heat to outside of the cylinder. In any of the above embodiments, gas entering the cylinder through an intake valve passes through the porous material, thereby cooling the porous material.

In any of the above embodiments, the method may further comprise separating a component from the gas, where an adsorbing material is used to adsorb the component while the gas is compressed, thereby creating a depleted gas. In a further embodiment, the adsorbing material is disposed in the porous material. In an alternate further embodiment, the method further comprises exhausting the depleted gas, and releasing the component through a different exhaust manifold during a different part of the cycle. In another embodiment, the adsorbing material is disposed in an exhaust manifold, such that the compressed gas passes the adsorbing material when the gas exits the cylinder after compression.

In any of the above embodiments, the method may further comprise injecting a fluid into the cylinder to scavenge the compressed gas, wherein the fluid evaporates in the cylinder. In a further embodiment, the fluid pushes the compressed gas through an exhaust valve. In another further embodiment, the fluid is exhausted through a second exhaust valve after the compressed gas exits the cylinder.

In any of the above embodiments, the porous material may have a higher thermal capacity than the gas.

In a third main embodiment, an engine is disclosed, comprising a cylinder comprising a top surface, a reciprocating piston, a porous material and a catalyst, wherein each is disposed between the piston and the top surface.

In one further embodiment, the catalyst may be disposed on the porous material. Alternatively, the catalyst may be disposed on a wall of the cylinder, on the piston or on a top surface of the cylinder.

In any of the above embodiments, catalyst loading in a first region of the porous material may be different than a catalyst loading in a second region. In a further embodiment, the first region is where gas enters the cylinder.

In any of the above embodiments, a catalyst in a first region of the porous material may be different than a catalyst in a second region. In a further embodiment, the first region is where gas enters the cylinder.

In any of the above embodiments, the porous material may be disposed on the top surface, and a thermal insulator may be disposed between the top surface and the porous material.

In a fourth main embodiment, a method of processing a gas is disclosed. The method comprises introducing a gas into a cylinder having a reciprocating piston, a porous material and a catalyst disposed in the cylinder between a top surface and the piston; and moving the piston in the cylinder to as to compress the gas, where the catalyst causes a chemical reaction with the gas during the compression.

In some embodiments, the catalyst is disposed on the porous material.

In any of the above embodiment, the method may further comprise controlling a temperature of the porous material.

In any of the above embodiments, the method may further comprise exhausting the gas after the compression; introducing a second gas into the cylinder after the exhausting, wherein the second gas reacts with products of the chemical reaction of the gas. In a further embodiment, the products comprise soot and the second gas comprises an oxidizer. In the above embodiments, the gas may be introduced into the cylinder through a first intake valve and the second gas may be introduced into the cylinder through a second intake valve. In an alternate embodiment, the gas may be introduced into the cylinder through a first intake valve and the second gas may be introduced into the cylinder through an injector. In any of the above embodiments, the gas may be exhausted from the cylinder through a first exhaust valve and the second gas may be exhausted from the cylinder through a second exhaust valve.

In any of the above embodiments, the push rod to crank radius may be varied to increase the time the cylinder is under high pressure.

In any of the above embodiments, the method may further comprise introducing a second gas into the cylinder, wherein the second gas reacts with the gas. In a further embodiment, the gas is introduced through an inlet valve and the second gas is introduced through a different inlet valve, and mixing of the gasses occurs in the cylinder. In an alternate embodiment, the gas is introduced through an inlet valve and the second gas is introduced through an injector, and mixing of the gasses occurs in the cylinder.

In any of the above embodiments, the method may further comprises performing other chemical reactions in the cylinder during other engine cycles in order to control the temperature of the catalyst.

In any of the above embodiments, the gas may comprise methane and the chemical reaction may comprise catalytic partial oxidation or millisecond catalytic autothermal reforming, thereby creating H₂ and CO.

In a fifth main embodiment, a method of producing syngas is disclosed where the method comprises introducing a gas into a cylinder having a reciprocating piston, a porous material and a catalyst disposed in the cylinder between a top surface and the piston, where the gas is a hydrocarbon; introducing a second gas into the cylinder, the second gas being an oxidizer; introducing CO₂ or H₂O into the cylinder to decrease the exothermicity of a reaction in the cylinder; and moving the piston in the cylinder to as to compress the gas, where the catalyst causes a chemical reaction between the gas and the second gas during the compression, thereby producing syngas.

In one embodiment, the piston is in communication with a crank shaft and a separate engine is used to rotate the crank shaft, thereby causing the piston to move in the cylinder.

In any of the above embodiments, the cylinder may be part of an engine having an additional cylinder, the piston may be in communication with a crank shaft and an additional piston disposed in the additional cylinder is in communication with the crank shaft, whereby the additional cylinder operates in a power generating mode and the additional piston rotates the crank shaft.

In a sixth main embodiment, a method of operating an engine is disclosed. The method comprises providing an engine having a plurality of cylinders, each having a reciprocating cylinder disposed therein, where a porous material disposed in each of the cylinders and a catalyst disposed on the porous material; introducing a fuel into the plurality of cylinders; combusting the fuel in the cylinder; and exhausting the combusted fuel from the cylinder, wherein the catalyst is selected to modify the composition of the exhausted fuel.

In one embodiment, the catalyst reduces cold start emissions. In another embodiment, the catalyst produces products used by an emission aftertreatment system. In a further embodiment, the product comprises hydrogen or ammonia.

In a seventh main embodiment, a method of operating an engine is disclosed. The method comprises providing an engine having a plurality of cylinders, each having a reciprocating cylinder disposed therein, where a porous material disposed in each of the cylinders and a catalyst disposed on the porous material; introducing a fuel into the plurality of cylinders; combusting the fuel in the cylinder; and exhausting the combusted fuel from the cylinder, wherein the catalyst is selected to stabilize the combustion process.

### BRIEF DESCRIPTION OF THE DRAWINGS

For a better understanding of the present disclosure, reference is made to the accompanying drawings, which are incorporated herein by reference and in which:

FIG. 1(a) shows a cylinder chamber having a porous material incorporated in the dead space of the cylinder of a reciprocating engine;

FIG. 1(b) shows a cylinder chamber having a porous material with a gap between the porous material and the cylinder head preventing interference between the valves and the porous material;

FIG. 1(c) shows a cylinder chamber having a porous material disposed on the bowl of the piston in a reciprocating engine;

FIG. 2 shows a cylinder chamber having a porous material that is supported by the cylinder head, but thermally insulated from the cylinder head by an insulated layer.

FIG. 3 illustrates inlet gas being used to cool the porous material.

FIG. 4 shows the scavenging liquid fluid injected near top-dead-center and evaporating in the porous material.

FIG. 5(a) shows a graph representing pressure and temperature within a cylinder in the presence of a catalyst;

FIG. 5(b) shows a graph showing gas composition in the presence of a catalyst;

FIG. 6 illustrates an engine system with multiple cylinders, some of which have different conditions than the other cylinders;

FIG. 7 illustrates a compact Gas-to-Liquid system using catalytic engines; and

FIG. 8 illustrates a compact gas-to-liquid system using both a catalytic engine reformer and a catalytic engine reactor for synthesis.

### DETAILED DESCRIPTION OF THE INVENTION

Conventional internal combustion engines can be considered chemical reactors, which are generally used for the purpose of full oxidation of a fuel in order to generate power. Unlike conventional engines, where the generation of power is the objective, the present disclosure describes a system and method that uses the introduction of a porous material in the dead space of an engine to provide gas compression and/or for driving catalytic chemistry for a number of applications.

General Description of the Engine

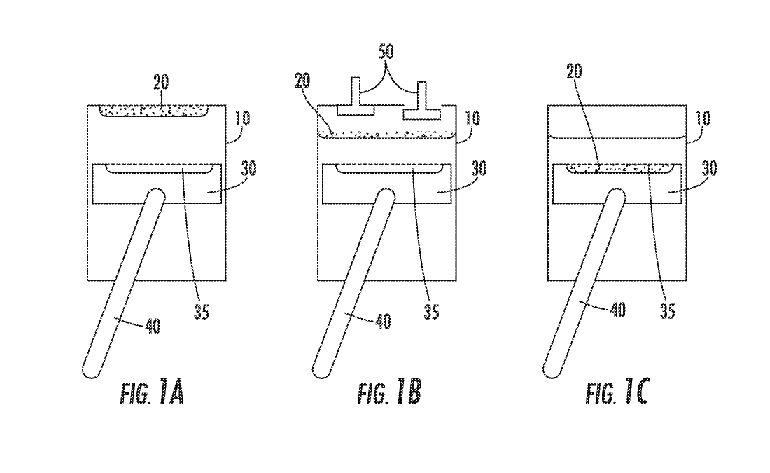

FIGS. 1(a)-1(c) show a schematic of three embodiments of the approach. Each of these figures shows a single cylinder chamber 10. It is understood that this cylinder 10 is part of an engine. Furthermore, the engine may comprise one cylinder or an arbitrary number of cylinders. As described below, one or more of the cylinders in the engine may be configured to include a porous material as shown in FIGS. 1(a)-1(c).

The cylinder 10 includes a reciprocating piston 30 attached to a push rod 40. In all embodiments, a push rod 40 is used to move the piston 30 vertically within the cylinder 10 toward a top surface. A plurality of valves 50 may be part of the cylinder and disposed on the top surface, which may be part of the cylinder head. The valves 50 may include a separate intake valve and exhaust valve. In some embodiments, there may be more than one intake valve or exhaust valve per cylinder. Although not shown the intake valve is in communication with an inlet manifold. Gasses from the inlet manifold pass into the cylinder 10 when the intake valve is open. Similarly, the exhaust valve is in communication with an exhaust manifold, such that gasses from the cylinder exit to the exhaust manifold through an open exhaust valve. In embodiments where the engine includes more than one cylinder, all of the cylinders may be in communication with a common inlet manifold and a common exhaust manifold. In other embodiments, separate inlet manifolds may be provided for each cylinder or set of cylinders. Similarly, a common exhaust manifold may be used for all of the cylinders in the engine. In other embodiments, separate exhaust manifolds may be provided for each cylinder or set of cylinders.

FIG. 1(a) shows a cylinder chamber 10 where the porous material 20 is disposed on the top surface of the cylinder chamber. FIG. 1(b) shows the porous material placed in the volume disposed between the top surface and valves 50 of the cylinder and the piston 30, with a gap between the porous material 20 and the valves 50. FIG. 1(c) shows a cylinder chamber 10 where a porous material 20 is incorporated into the piston bowl 35 of the piston 30.

In all embodiments, a substantial fraction (such as more than half) of the volume in the cylinder chamber 10 at Top Dead Center (when the volume of the cylinder 10 is at a minimum) is filled with a porous material 20. In another embodiment, not shown in FIG. 1, piston 30 may be opposed, such as in an opposed piston configuration, with the porous material 20 disposed in a substantial fraction of the space between the two pistons at the time when they are closest.

In some embodiments, the engine can operate with camless valves 50, actuated hydraulically or electrically. In this manner, it would be possible to adjust, in realtime, the operation of the engine, to compensate for changes in inlet conditions or conditions in the cylinder chamber 10.

As described above and in FIGS. 1(a)-1(c), the porous material 20 can be placed in several locations. It can be attached to the cylinder head (as shown in FIGS. 1(a) and 1(b). If attached to the cylinder head, there are gaps in the porous material so that the porous material does not interfere with the valves 50 when open, and the intake/exhaust flows will go through the porous material 20. The arrangement in FIG. 1(b) may prevent the interference between the valves 50 and the porous material 20, allowing a gap in the dead space. In an alternative embodiment, the porous material 20 is placed on the piston 30. Alternatively, the porous material 20 can be placed on the bowl 35 of the piston, as shown in FIG. 1(c). However, other locations are also possible. In another example, the porous material 20 may be attached to one or more of the valves 50 in the cylinder 10, so that it moves when the valve 50 moves. In another example, porous material 20 may be placed in the bowl 35 and on the cylinder head. In yet another different embodiment, the porous material 20 can be attached to a plug that replaces a fuel injector or a spark plug. In this manner, it is possible to introduce the material into the cylinder 10, and replace it, without the need to open the cylinder 10 (by either removing the cylinder head or the pistons/cam). The porous material 20, if ductile, can be introduced into the cylinder 10, and cylinder 10 and/or valve 50 motion deforms the porous material 20 so that it complied with the cylinder geometry with the cylinder 10 is at top dead center and when the valves 50 are open. Metallic foams, in particular, are easily deformed. The porous material could be attached to the plug for ease of removal when needed.

The porous material may include a support frame or plates, for structural purposes.

Description of the Porous Material

The porous material can be open-cell structures, or it can be honeycomb (as used in other automotive components for catalyst support and other applications) or other regular geometries. These honeycomb materials are available both in ceramic as well as in metallic forms. It could also be a granular material held in place by a sheath or a mesh.

If there are concerns about particular matter or other solids in the reaction (either in the inlet or generated in the reactor), the porous material can be in the form of a DPF (diesel particulate filter), with adjacent honeycomb channels closed shut in opposite ends of the porous material. In this case, the gas needs to flow through the walls of the porous material, leaving the solids behind. Means of regenerating the porous material are provided in subsequent cycles. For example, soot can be oxidized in subsequent cycles, as will be described later.

In addition, other structures, such as fibrous, microchannel or aerogels could also be used. In the case of the microchannel, dimensions may be such that the flow is not very restricted (in terms of pressure drop) and should provide adequate porosity.

In one embodiment, the porous material 20 may be a metallic or non-metallic foam. Metallic foams have been available for many years. They are made of a variety of metals, including aluminum, copper, nickel, tin, zinc, nickel, iron, silver, and gold. Alloys include steels and inconel. In terms of non-metal, these foams can be made from vitreous carbon, alumina, silicon carbide, cordierite, aluminum titanate, and others. It is not meant to be exclusive of other materials. Metallic foams are attractive because of the ductile nature of the material, as opposed to ceramic, brittle foams. Although reticulated porous materials are preferred because of the high porosity, other porous materials can be used. Depending on the application, at lower temperature, organic materials could be used. Any porous material that can support the conditions in the engine could be used.

In an alternative embodiment, the porous material may comprise fibrous materials or memory materials. Compressible fibers, such as glass fibers or thin metallic strands (for example, metallic wools or sponges), or other types of wool-like materials (metallic or organic or ceramics) can be used. These materials can be deformable, as opposed to ceramic foams. The metallic foams are deformable, but they have substantial strength and will remain in the deformed state. In contrast, the wools or sponges can be elastic, in that they can be made to recover their initial state after deformation, with or without the use of additional springs to return the fibrous material to its original shape. In this manner, it is possible to compress the deformable porous material and achieve higher compression while at the same time releasing a substantial fraction of the gasses in the cylinder if the exhaust valve is open. The difference in mechanical behavior between the metallic foams and the metallic sponge is that in the case of the metallic foam there is a 3-dimensional grid structure that connects the material in all 3 dimensions. Deformation in the metallic foams occurs by plastic deformation of the struts in the foam. In the case of metallic wool or sponge, the material is a loose connection of filaments, with minimal interconnection, and deformation is elastic. In some cases, springs can be used to return the material to the initial state, the springs can be by extension or by torsion, either coil spring, flat spring, cantilever spring, volute spring or any other type of spring.

In the case of the deformable material, it is advantageous to prevent oil contamination from the porous material. The sides that are facing the cylinder walls, which have a coating of oil, can be covered by a coating or thin sheath, which may be flexible so that it moves with the deformable fibrous material. Depending on the temperature of the application, the sheath can be made from a metal (such as bellows) or it can be made from an organic material, such as plastic or other elastometers.

The porosity of the material can be as low as 30-40% or as high as 90-98%.

The presence of porous material 20 in the cylinder chamber increases dramatically the thermal mass of the materials in the cylinder chamber 10. For example, at 100 bar and 800 K, the density and heat capacity (cᵥ) of methane/oxygen (2:1) mixtures are ˜30 kg/m³ and 2.2 kJ/kg-K, for a volumetric heat capacity of about 70 kJ/m³-K . In contrast, copper has a density of 8,900 kg/m³ and a specific heat capacity of 0.45 kJ/kg-K. Even with a porosity of 96%, the volumetric heat capacity of copper foam is 150 kJ/m³-K or about twice that of the gas. This allows for the possibility of having the porous material 20 and the gas at different temperatures (non-equilibrium, thermal conditions). In the case where the porous material 20 includes a catalyst, it is thus possible to adjust the temperature of the reaction by the selection of the properties of the porous material 20, allowing the optimization of the reaction conversion or selectivity. The porous material 20 can provide thermal inertia, limiting the temperature during the reaction. In addition, it can provide for high temperature for driving the reaction. The additional control is very effective in allowing operation at different stoichiometries and different chemistries, decreasing the large thermal gradients that would arise due to the exothermic reactions (such as partial oxidation) and to reduce the spatial concentration gradients.

Gas flowing through a porous material 20 experiences a pressure drop. In addition, the gas needs to get into the porous material 20 during the compression cycle and exit from the porous material 20 during the expansion cycle or during the exhaust cycle. Therefore, a pressure difference exists through the porous material 10. However, the impact is small, with low pressure differences. The size of the pores can be adjusted to decrease the pressure drop at the high flow rates associated with fast engine speeds. For a typical 15 liter engine operating at 1500 rpm, the pressure drop across a 1.5 cm thick foam with 92% porosity (10 pores per inch, PPI) will be about 0.5 psi, which is negligible compared with ambient pressures of about 1600 psi (100 bar). The porous material 20 experiences small forces because of the small pressure drop. For a porous material with 40 PPI, the pressure drop would be about 1 psi.

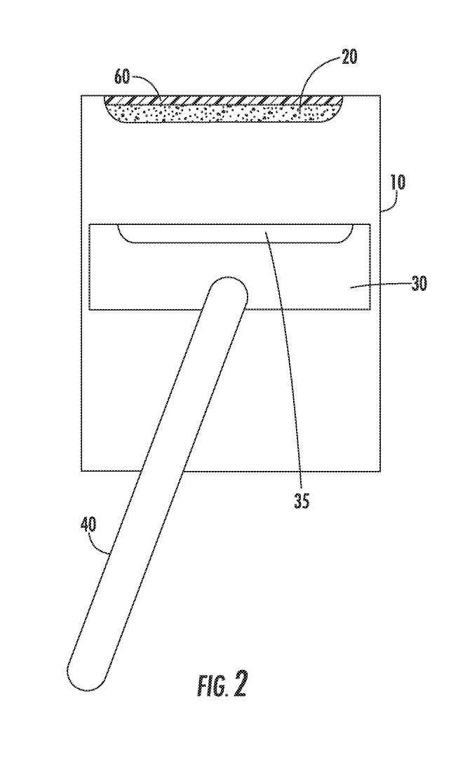

The temperature of the porous material 20 and/or catalyst is determined by the temperature of the inlet gas, the gas heating due to compression, the heat of reaction on the catalyst, and the losses. Depending on the location of the porous material 20, the heat losses can be controlled. If it is in the piston bowl, as shown in FIG. 1(c), the losses are low, while they can be higher if it is in good thermal contact with the cylinder head. The use of thermal insulators around the porous material could minimize heat transfer with the porous material 20, if desired. An example of the placement of the thermal insulators 60 is shown in FIG. 2. In this embodiment, thermal insulators are disposed on the cylinder head, between the top or head surface and the porous material 20. It should be noted that because of the high surface to volume area in the porous material 20 and the turbulence induced when the gas enters and moves through the porous material, there is high heat transfer rate between the porous material and the gas. The gas would be at about the same temperature as the porous material 20, with good thermal contact. That is, the thermal inertial of the porous material 20 can be used to control the temperature of the gas and the reaction rate at the surface of the porous material 20, without the need of heat transfer in a conventional heat exchanger, where heat is transferred through surfaces. Better temperature control of the gas and/or the porous material is possible in this manner. In addition, non-contact heating mechanisms, such as electrical, microwave or infra-red power, can also be used to heat the porous material or catalyst, if higher temperatures are desired. These non-contact heating mechanisms can be used to control the temperature of the porous material 20. The thermal conditioning of the porous material may be also provided by the gasses themselves, or by reaction in the cylinder that releases energy (for example, combustion). One or more cycles can be used to condition the porous material before continuing the desired process with the engine in subsequent cycles.

It is possible to use a porous material 20 with different characteristics in the cylinder 10. For example, the porous material 20 in one region of the engine may have a different pore density (PPI) than that in another region of the engine; and/or the porous material 20 in one region of the engine may have different porosity than that in another region of the engine; and/or the porous material 20 in one region of the engine may have different materials than that in another region of the engine. The changes in material can be discrete (for example, using two different porosity/PPI/composition metallic foams) or the change can be continuous, or a combination of the two. In addition, it is possible to use orifices or restrictions to the flow in the cylinder 10, in order to maximize the interaction of the gas with the porous material 20. The orifice could be located in the region downstream from the porous material but upstream from an empty region in contact with the valves.

Engine as a Compressor

The inclusion of a porous material 20 in the dead space of engine, without or without the deposition of a catalyst on the surface of the porous material 20, enables efficient operation of engine-based compressors. The compression cycle in the presence of a porous material 20 over a substantial fraction of the dead space can be used for obtaining near-isothermal compression. The temperature of the gas in the porous material 20 is controlled by the porous material 20. However, because the porous material 20 does not fill the entire volume of the gas undergoing compression, there remains substantial, but much reduced, compression gas heating.

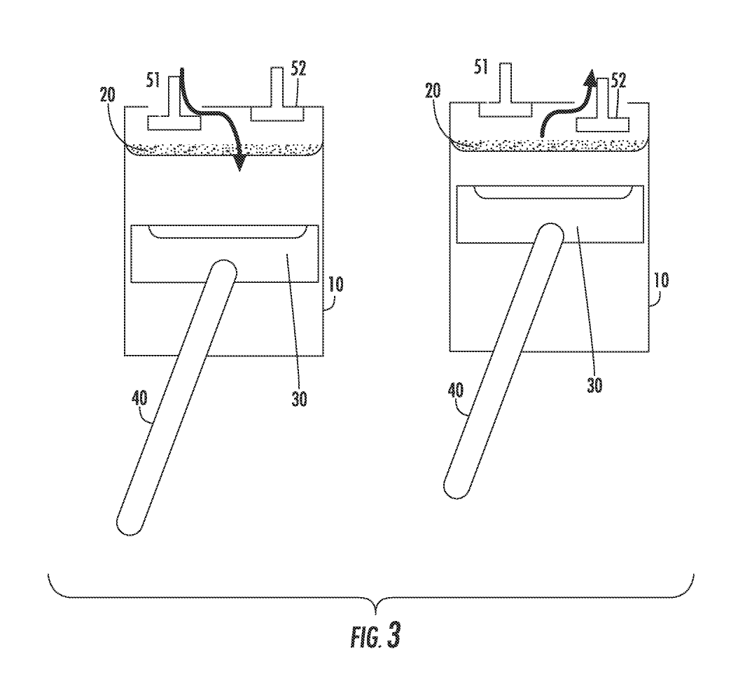

The engine compressor can operate using 2 or 4 strokes per cycle. When the engine is used as a compressor, a non-catalytic porous material 20 is used to maintain a lower temperature of the gas during the compression process, decreasing the power requirement and allowing larger compression ratio for a single stage. The lower temperature of the gas is maintained by the use of the large thermal mass of the porous material 20, as compared to that of the gas that is being compressed. The porous material 20 can be maintained at a cool temperature by one of several methods: Cooling through the cylinder head (i.e., the coolant passing through the cylinder head removes heat from the porous material 20), or with coolant that goes in separate tubes that go through the cylinder head of the engine. In another embodiment, the porous material 20 could be cooled by a heat pipe, or by thermal conduction to the outside. In addition, by cycling the gas, as shown in FIG. 3, it is possible to maintain a lower temperature of the porous material 20. That is, the gas that is introduced into the cylinder 10 through the intake valve 51 during the intake stroke can be used to cool the porous material 20, in addition to or instead of the methods described above. Heated compressed gas is passed through the porous material 20 and through the exhaust valve 52 during the exhaust stroke. The porous material 20 could be attached to either the piston 30 or the cylinder head of the engine, or to one or more of the valves 51, 52, or a combination of the above. The porous material 20 does not have to fill all the space, as there is the need for clearing the valves 51, 52 when they open. Thus, there can be a gap between the porous material 20 and the valves 50, as shown in FIG. 1(b).

The gas compressor can be used to pressurize air, natural gas (with or without natural gas liquids), CO₂, CFC's and HFC's refrigerants or others.

The near isothermal compression, with temperature determined by the temperature of the porous material, could be attractive for refrigeration. The compressor and heat exchanger (to a fluid) could be used for efficient, inexpensive refrigeration systems. The refrigerant may be released at the temperature of the porous material 20 or lower (if it is allowed to partially expand in the cylinder, for those conditions where there is a gap between the porous material 20 and the exhaust valve). Many refrigerants can be used, such as CFC's, HFC's, CO₂ and others.

Near isothermal compressors may be very attractive for use in automotive applications. The engine compressor with the porous material 20 can be driven electrically or through belts that are attached to the main engine, or through belts/gears/clutch system. In some applications, one or more of the cylinders 10 in the engine could be used for the air compression. The near-isothermal nature of the compressor decreases the power required, and avoids the need of an intercooler downstream from conventional superchargers or turbochargers. It may also allow the use of higher inlet manifold pressures, which are limited in part today with conventional technologies by the need of multiple stage compression. Thus, compressed gas exhausted by the cylinder may be used as the inlet gas for another cylinder, in that engine or in another embodiment. In this way, the compressor behaves as a super- or turbo-charging unit for another engine.

The compressor can be used for gas separation. Thus, a gas with multiple components can be pressurized near isothermally. The pressurized gases pass through a bed with preferential adsorption of one constituent in the gas, and the remaining gas is then decompressed. It is possible to apply the gas adsorber as part of the porous material 20 in the cylinder. In this case, the depleted gas is exhausted at pressure and it is expanded in a separate cylinder. The remaining compound in the adsorbing material is then released during the expansion phase, and exhausted through a different valve. In another embodiment, the pressurized gas without separation is exhausted at pressure, passed over the adsorbing bed where it preferentially withholds one of the compounds, and the depleted gas is then optionally introduced into a different cylinder where it is expanded, recovering some of the power provided in the compression. The gases to be separated include air, with oxygen or nitrogen separated from the air, or hydrocarbons, such as methane mixtures with other light hydrocarbons (such as ethane). Other uses could include separation of CO₂ from syngas (for ammonia manufacturing), or hydrogen sulfide from hydrogen, or removal of CO₂ from biogas (to upgrade biogas). The engine speed and the valve lift/duration may be adjusted. Thus, the duration of the compression is determined by adsorption of the gasses onto the adsorber, the duration of the exhaust is adjusted in order to prevent desorption of the adsorbed gases during the exhaust phase of the depleted gasses. Engine speeds as low as 60 rpm could be used.

Compressor Scavenging

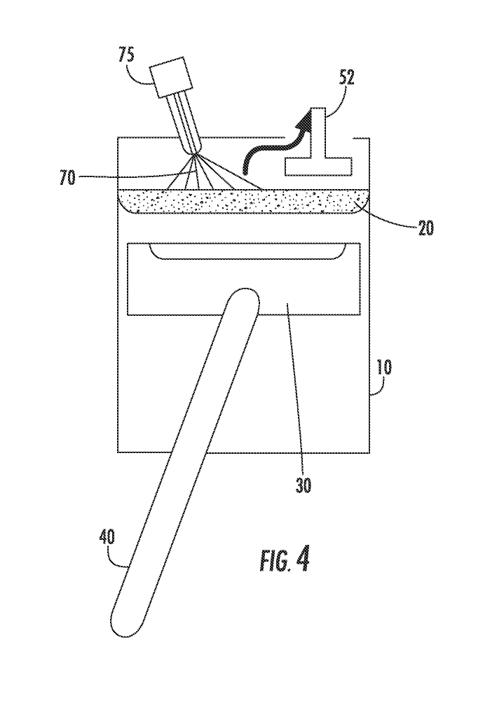

It is possible to use a separate fluid to scavenge the high pressure gases, with or without the use of a catalyst on the porous material 20. One embodiment may use a liquid fluid, so that the power required for compression of the scavenging fluid is reduced, as shown in FIG. 4. The scavenging fluid 70 may be introduced into the engine near top dead center by an injector 75. The scavenging fluid 70 may be evaporated by the hot compressed gas, or it may be heated by the porous material 20. The scavenging fluid 70 may partially mix with the high pressure gas and be exhausted through the exhaust valve 52 with the high pressure gas. Alternatively, with limited mixing between the injected scavenging fluid 70 and the high pressure gas, the scavenging fluid 70 may drive the high pressure gas out of the cylinder 10 through exhaust valve 52, replacing it with the injected vaporized fluid. The injected fluid 70 can cool the porous material 20 (with or without a catalyst). After the high pressure gas has exited through exhaust valve 52, the scavenging fluid 70 may be exhausted separately from the high pressure gas by using a separate exhaust valve and a separate exhaust manifold (not shown) (to minimize loading the compressed gas with the scavenging fluid 70) after limited expansion of the scavenging fluid, in order to recover some of the energy spent in the compression process. If the scavenging fluid 70 is exhausted before the piston reaches Bottom Dead Center, then the inlet valve may need to open, introducing the gas to be compressed at a time when the pressure in the cylinder is lower than the pressure at the inlet manifold with the gas to be compressed. Otherwise, additional power will be required to provide a vacuum (relative to the inlet manifold). The gas to be compressed can be introduced using a check-valve, instead of an electrically, hydraulically or otherwise actively actuated valve. Alternatively, the engine could operate with 4 or more strokes, in order to release the scavenging gas 70 in a subsequent cycle to the compression cycle, through a different exhaust valve and exhaust manifold.

Description of the Catalyst

The porous material can be coated with a catalyst. The catalyst can be applied directly to the porous material 20, or it can be applied to a coating on the porous material 20. Alternatively, the catalyst itself can serve as the porous material, or the catalyst can be applied to a granular substrate that has high porosity and comprises the porous material.

The porous material 20 may be metallic, or it may be non-metallic. In one embodiment, metallic foam materials may be used; however ceramics and the like, and many other materials may also be used. These porous materials 20 are available in many configurations, with variable pore size and porosity, as described above. The porous material 20 may be aluminum, copper, nickel and their composites. The porous materials 20 are robust.

On the surface of the porous material 20, a catalyst and/or washcoat may be deposited. Metallic foam catalysts have been used in the past, but not in engines, and not in pulsed (rapidly cycled) applications. In another embodiment, the catalyst may be deposited throughout the pores of the porous material 20. In another embodiment, the actual porous material 20 itself may exhibit catalytic properties or may be coated with the catalyst.

Porous materials have been used as catalyst supports, and in particular, catalysts have been applied on reticulated metallic foams. For example, vanadia and titania have been applied on stainless steel foams, with good performance. Rhodium has been proposed for catalytic conversion of methane, and it has been tested on foams. It is found for example, that the main reason for deactivation of the rhodium catalyst is due to thermal deactivation due to sintering, which is caused by the highly exothermic reaction in the reaction zone. It seems that deactivation is due to the high temperatures upstream in conventional catalytic reactors (with continuous flows). Because of the nature of utilizing a catalyst within an engine, it is possible to have a “batch” type conversion, with better thermal control. This can be achieved if conditions for reforming are reached at near top dead center. The issues of high oxygen conversion upstream of the catalyst in a flowing catalytic reactor would not occur in the case of an engine catalyst where most of the foam will be at relatively uniform temperature with relatively stationary gas behavior during the reforming operation (with the charge neither entering nor leaving the monolith).

In another example, the catalytic coating may be applied directly to the piston 30, cylinder 10, or cylinder head, in the presence of a porous material. The porous material 20 may or may not have a catalyst coating. The purpose of the porous material is to control the temperature/pressure of the cylinder 10.

There is a wide range of catalysts available for catalytic reforming. For methane, catalytic partial oxidation, materials from the group VIII metals, such as rhodium, platinum, ruthenium, iridium, nickel, and cobalt may be used. These metals are usually applied on an oxide substrate. Other elements may also be used. Some of these catalysts are very effective, but they also promote carbon formation. Transient reforming allows for relatively short contact time, limiting the time to build carbon on the surfaces. Furthermore, even if carbon forms on the surface, it may be relatively easy to use an oxidizer cycle without hydrocarbons, in order to promote soot burn-up. Thus, the use of engine catalysis opens an opportunity to address issues with some of the more active, and less expensive, catalysts for methane catalytic partial oxidation. Other types of metals or metal oxide catalyst may be used, including alkali or alkaline earth metals, or any other type of catalysts.

Rhodium is well known to provide very good performance in methane catalytic partial oxidation. It has also been determined that it can operate at high pressure, without affecting the conversion of methane. No degradation was observed for the rhodium catalyst, although degradation has been observed in platinum. In the present application, much higher pressures are expected, as high as 150-200 bar (after conversion, if there is substantial generation of water and CO₂).

Under some conditions and for some of the processes, it is advantageous to coat different sections of the porous material with different catalyst and/or with different catalyst loadings. For example, the regions of the porous material 20 where the gas enters would be coated with either less partial oxidation catalyst or more steam or dry reforming catalysts, while the sections away from the regions where the gas enters the porous material 20 would have higher loading of the partial oxidation catalyst. In this manner, it is possible to control the exotherm in the region where the unreacted oxidizer/fuel enters the porous material (that contains a substantial concentration of free oxygen), thereby avoiding large temperatures at the region of the catalyst in contact with the open space in the cylinder. In addition, there could be a gradient in porosity in the porous material. Thus, there can be a gradient in the catalyst loading in the porous material. There can be more than one catalyst type, each with its own gradient. It should be emphasized that the reagents that enter the porous materials first have substantially longer residence time than the reagents that enter when the piston is near top-dead-center. The gradient in catalyst is useful in compensating for the differences in residence times.

The catalyst temperature can be controlled either by controlling the inlet temperature of the reagents, by adjusting the chemistry (making it endothermic, exothermic of energy neutral) or by providing external cooling/heating. As an example, in the case of autothermal reforming, the addition of oxygen can be used to adjust the energy balance of the reaction. In the case when the porous material 20 is attached to the cylinder head of the engine, the temperature can be controlled by adjusting the temperature of the cylinder head. In addition, it may be possible to use separate heating/cooling through the cylinder head with a porous material 20 that is thermally insulated from the cylinder head (see FIG. 2). The heating/cooling fluid may go in thermally insulated tubes through the cylinder head. The tubes can be continuous flowing, or a heat pipe, or just by thermal conduction to the outside of the cylinder head, where the temperature can be adjusted through external heater or coolers. When connected to the cylinder head, electrical, RF or infrared heating of the porous material/catalyst may be desirable for controlling the catalyst temperature. In the case of when the porous material 20 is on the piston 30, either lubrication oil sprayed at the piston (on the side not facing the reaction zone) or control of the liner temperature are means of controlling the temperature of the catalyst.

It is possible to use both gas phase and catalytic reactions in the reformation process. Reactions on the volume (homogeneous reactions) are slower than those on the catalyst, and thus it is possible to achieve yields that are higher than those typically achieved at equilibrium at the gas temperature and pressures, enabled by the transient nature of the process and the fact that the catalyst is at different temperature (either higher or lower).

Multiple Chemistry

The reciprocating nature of the reactor allows for multiple cycles with different chemistry. For example, during the first cycle of the engine, one set of reagents are used. A different set of reagents are introduced into the same cylinder 10 in order to provide different chemistry during a second cycle that is after the first cycle. In one embodiment, the first cycle may result in a reaction that produces a product, which optionally remains in the cylinder. The second cycle may then use a different chemistry which reacts with the product created by the first set of reagents. One example may be that the first set of reagents produces, among other products, soot. The second cycle may use a different chemistry that oxidizes the soot created by the first set of reagents.

Alternatively, a different cycle altogether is used, with different chemistry. For example, if there is a process that slowly builds a layer on the catalyst or the porous material 20 (for example, soot), every few cycles, or when needed, a different chemistry is used to condition the catalyst. In the case of soot, an oxidizer is introduced to burn the soot. In the case of sulfur poisoning of the catalyst, a gas can be introduced to remove the sulfur, through oxidation for example. However, the nature of the layer or the required conditioning (including regeneration of a catalyst) should not be limited to soot deposits. For example, a reducing agent, such as hydrogen, can be used to recondition the catalyst.

The catalyst may be deactivated by coke formation. It may be possible to adjust the composition of the reagents during one or more cycles, periodically, in order to remove the coatings and reactivate the catalyst. Other means of regenerating or reconditioning the catalyst are also possible, such as by introducing oxidizing or reducing agents, or other gases that deposit fresh catalyst. Because of the relatively large thermal mass of the catalyst with respect to the air in the cylinder, temperature excursions during these discrete events to remove the coke can be limited. Reconditioning may also be achieved by a chemical reaction that generates sufficient heat to eliminate the coke.

Operation with different chemistry could occur during several cycles in sequence, and it can occur sporadic during the process, when needed or when timed.

There are other ways of conditioning the catalyst. For example, it may be that the desired temperature of the catalyst is within a narrow range. If the reaction is endothermic, it is possible to interleave some exothermic cycles to bring the temperature back to the desired range, through the use of different chemistry. Similarly, it may be possible to reduce the temperature of the catalyst, if too high, by the use of different chemistry or no chemistry, just cooling through the use of enthalpy of the injected gas or liquid.

When multiple chemistry is desired, it may also be desired to have different means of introducing and/or exhaust of the gases. In the case of inlet, it could be used through direct injection through separate injectors, or through inlet valves that are disabled when not in operation. Alternatively, the different reagents may be introduced into the manifold, with limited mixing of both reagents for a short period of time while it adjusts the composition. Those reagents can be introduced into the manifold through valves or through injectors. For the exhaust, if it is desired to keep the two products separate, there needs to be multiple valves, some of which are deactivated during a period of time. In this manner, it is possible to have different exhaust manifolds for the different products. During the transient between one set of products and the other, it is possible to exhaust the products through either exhaust.

To get full control of the valving, it may be desirable to have hydraulic or electrically driven valve actuators. However, mechanical actuators that are disabled when needed could also be used.

It may be possible to use multiple cylinders with different chemistry. The different chemistry may occur in adjacent cylinders. The process may not be reciprocating but rotary, or through the use of opposed pistons. In the case of a V-type engine (V6 or V8 or other), it may be possible to do one set of chemistry in one bank, and the other chemistry on the opposite bank, with one of the bank's exhaust facing the inlet of the opposite bank.

Engine Reactor Characteristics

The nature of the process allows for periodic transient operation of the unit. The time constant is determined by the engine speed. High pressure engines (such as diesel engines used for heavy duty) operate at relatively low engine speeds, below about 2,000 rpm, although higher speeds could be used, such as up to 10,000 rpm or more. Under these conditions, the time at high pressure is on the order of a few milliseconds. Thus, processes with chemical kinetics that require substantially more time may not be suitable for use with a catalytic engine. The chemistry of the process (including parameters such as the concentration of the reagents, the temperature, the pressure, the nature of the catalyst, and the catalyst load) needs to be matched to obtain adequate conversion. Alternatively, the conditions in the cylinder 10 can be adjusted in order to provide adequate reaction (reforming or other reactions) with varying composition of the reagents. For example, conditions in the cylinder may be modified by adjusting the oxidizer addition, varying inlet temperature/pressure, or adjusting valve timing (through the use of variable valve timing).

The ratio of the engine connecting rod, or push rod 40, to crank radius can be adjusted to increase the time at high pressure. In this manner, longer time at conditions of high power, when the all or most of the reagents are within the porous element, can result in increased conversion.

The catalytic engine can operate either as a 2 cycle engine, with exhaust when the piston 30 is near top dead center, as a 4 stroke engine, or as an engine having an even higher number of strokes per cycle. It may be possible to change the engine operating conditions in order to have multiple cycles with the same gas. A 4 or a 6-stroke engine, for example, may be desirable to achieve higher conversion, with two or 3 compression cycles to increase conversion (and address issues like crevices and other regions absent of catalyst). The valve motion and the engine cam may have to be modified in order to allow 6-stroke operation of the engine.

Conditions of the reaction can be adjusted so that catalytic operation starts occurring only during a specific engine phase, such as near top-dead-center. It is possible to adjust the time of the conversion by adjusting the composition of the mixture, or by adjusting the conditions in the manifold, such as pressure, or temperature, for example.

It is possible to adjust the chemistry of the process, by adjusting the composition of the reagents, the residence time, the temperature or the pressure, either near real time (i.e., cycle to cycle) or slow rate of change (i.e., over many cycles). Conversion of methane to syngas is of widespread interest for gas-to-liquid production as well as for ammonia manufacturing. Methane can be converted using partial catalytic oxidation, although there is still substantial exothermicity of the reaction, reaching temperatures that exceed the allowable temperature for the porous material 20 or the catalyst if done in a continuous-flow system.

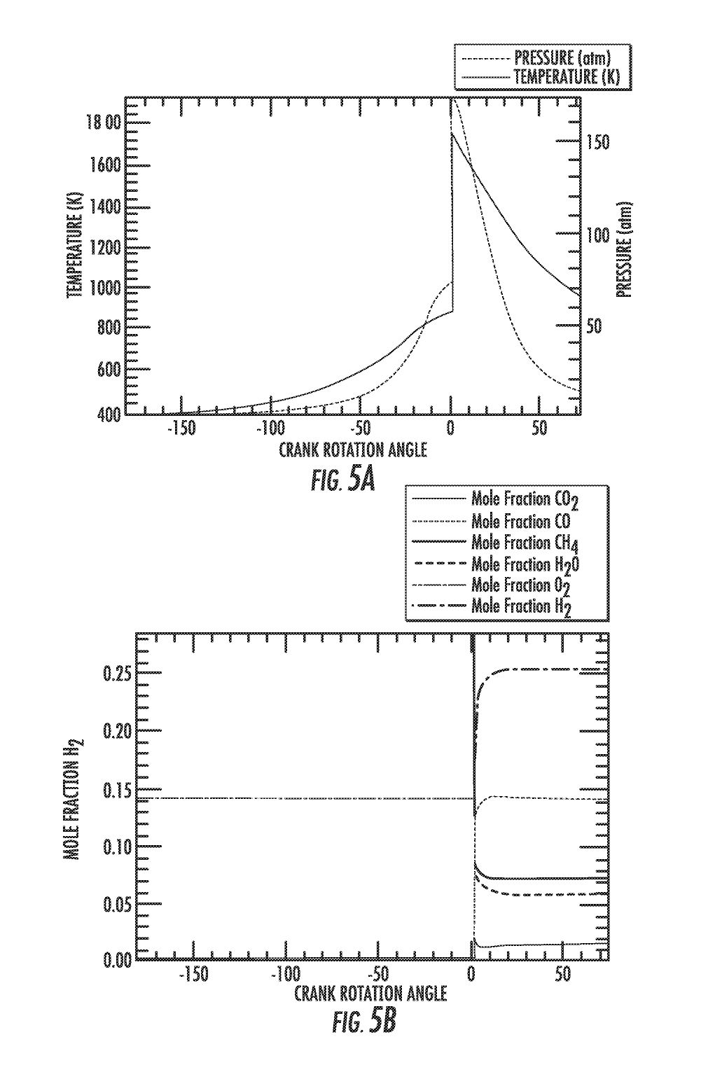

The catalytic partial oxidation of methane in air in an engine has been modeled by using chemical kinetic code CHEMKIN. In order to simulate the influence of a catalyst, the gas phase reaction rates have been arbitrarily increased by a factor of 200. The GRI-3 mechanism for methane was used, and the results are shown in FIGS. 5(a)-5(b). The engine is simulated as having a compression ratio of 16:1, and inlet temperature and pressure of 385 K and 2 bar. In the absence of chemistry, the peak temperature and pressure are about 850 K and about 70 bar.

When the gas phase reactions are increased (arbitrarily by a factor of 200), the resulting pressure and temperature is shown in FIG. 5(a). The composition of the gas is shown in FIG. 5(b).

Although in the above example, the methane conversion is only about 75%, it will be more for catalytic reforming, instead of gas reforming with accelerated reaction kinetics. In particular, the use of a catalyst may decrease the exothermicity of the reaction by being more selective to H₂ and CO, instead of producing substantial amounts of water and CO₂ that come as a result of large exothermicity of the reaction. In addition, the catalyst may spread the exotherm and make it more uniform across the catalyst.

The use of reciprocating engines can enable the use of very fast millisecond reforming. Thermal control of such catalytic systems with conventional topology is difficult with millisecond reforming, especially when it is exothermic, as in the case of millisecond partial oxidation. In the case of reciprocating engines, thermal control is enabled by control of the temperature through multiple cycles, and through thermal control as described above. The thermal control is possible for both exothermic as well as endothermic (and energy neutral) reactions. Thermal control is feasible with millisecond autothermal reforming, as the temperature can be adjusted as described above, even though the reaction is energy neutral. Both millisecond catalytic partial oxidation and millisecond catalytic autothermal reforming of methane can be used with the reciprocating reformer.

The engine speed can be adjusted to match the rate of conversion. Lower engine speeds increase the time allowed for reactions, although it decreases the allowable throughput. Engine speeds can be as low as 100 rpm. It is possible to increase the throughput of the engine catalytic reactor by injecting the reagents at high pressure. The pressure at the inlet is determined by the compressors upstream, and limited by the inlet manifold, which could be strengthened to tolerate high pressures and, if needed, high temperatures. For some reactions, the high pressure reduces the conversion rate, but with a catalyst and with increased residence time, the effect can be compensated.

The process is complex, as the thermal mass of the catalyst dominates. Thus, under some circumstances, the gas is at lower temperature than the porous material 20. As the gas enters the porous material 20 (driven by the piston 30), the gas heats up, increasing the temperature beyond that from what would have been due to adiabatic compression due to the piston motion (the increased temperature by additional heating from the porous material 20). As more gas gets in, under some circumstances, it is possible that the porous material 20 actually cools the gas. There are also reactions on the catalyst that could slowly (over several cycles) affect the temperature of the porous materials 20, as the thermal mass of the porous material is large relative to the gas. A model of the process requires a non-stationary reactor with non-thermal conditions in the porous material 20 (as the gas temperature differs from that on the porous material 20).

During the expansion stroke, the gas in the cylinder 10 is close to the temperature of the porous material 20. If the products are not exhausted, as the gas exits the porous material and the pressure in the cylinder 10 is further reduced (by the cylinder motion), it is possible to cool substantially the gas in the cylinder 10 (and in particular, the gas that is outside of the region occupied by the porous material 20). The cooling can be used in the process, if desired. For example, it may be possible to condensate the products of the reaction (for example, methanol or ammonia), separating them from the gas. The separation of the two phases (liquid product phase and gaseous reagent phase) can occur in the cylinder 10 or outside of the cylinder.

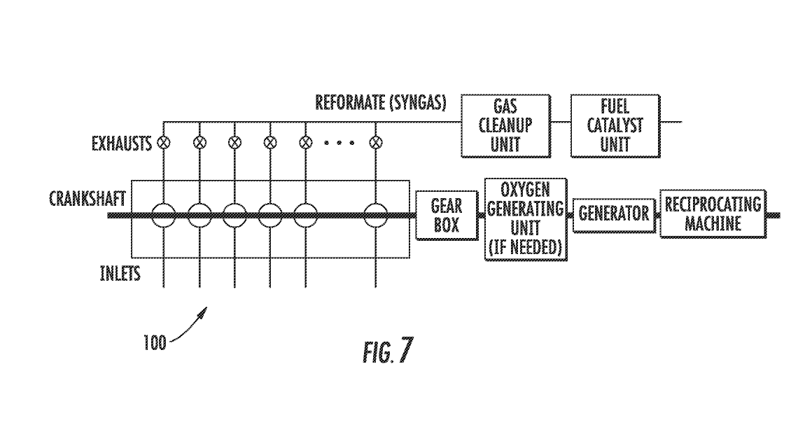

In another embodiment, the system shown in FIG. 7 may be used to generate a particular type of reformate, syngas, or other type of gas, which is directly filled into a holding vessel such as a tank. Alternatively, the gas can be separated in the receiving tank, with one of the compounds stored. Thus, in the case of hydrogen, hydrogen can be generated in the catalytic engine reactor and stored in a liquid organic hydrogen carrier, which requires the syngas to be at high pressure. The hydrogen depleted gas can then be expanded in a separate cylinder to reduce the power requirements for the system.

In a different application, the engine compressor using the porous material 20 is used to generate gas which is directly compressed into gas cylinders in a gas production process, without chemical changes to the gas or gases (for example for compressing natural gas for storage).

The illustrative reforming reactions could include any hydrocarbon, such as methane or ethane, and an oxidizer that includes free oxygen, such as air, oxygen enriched air, oxygen, or combinations of the above with CO₂ or H₂O. The use of the CO₂ (dry reforming) and H₂O (steam reforming) is to decrease the exothermicity of the process, making it more energy neutral and avoiding the large temperatures obtained in the case of partial oxidation alone. Autothermal reforming (energy neutral reforming between partial oxidation and steam reforming) can be used, as well as a combination between partial oxidation and dry reforming. Both steam and dry reforming are highly endothermic reactions and can be used to balance the exothermicity of the partial oxidation reaction. The advantage of autothermal reforming is that the size of the air separation plant, if one is used, is substantially smaller than in the case of partial oxidation. The reagents may also include hydrogen or syngas, either from the tail of a system that generates liquids (methanol, FT diesel or others) or separated from the tail of such a system. Alternatively, the reagents may be generated by excess motive power (converted to electricity) in the system, such as by electrolysis or by a reverse Solid oxide fuel cell or similar electrochemical device.

In addition to manufacturing of syngas, the catalytic engine reactor can be used to synthesize chemicals. The reactor reagents can be syngas, nitrogen, with or without diluents. The very high pressures allowed by the use of the chemical engine reactor allows for high conversion of the reagents, and permits the use of recycling to use multiple passes through the reactor.

Other chemistries are enabled by the use of engine reactors.

Limited exothermicity of reaction can be used to balance friction in the engine or even to generate small amounts of power, to minimize the engine power requirements. Large exothermicity in the catalytic reaction can be managed by the thermal control described above, and can result in power generation in the engine cycle. Exothermic reactions for manufacturing of fuels, such as methanol or FT which are exothermic, could result in net production of power. Other reactions, such as production of ethylene from natural gas that are endothermic, could be driven by operation of other cylinders in such a way as to produce power, used to drive the other cylinders where power is needed.

The engine, depending on the temperature of the porous material 20, may produce cooled products. If the temperature of the porous material 20 is relatively low (such as lower than the adiabatic temperature of the gas for the effective compression ratio of the engine), then during the adiabatic expansion of the gases, the gases will be cooled to temperatures lower than those during the intake phase. Thus, the engine reactor/compressor can also operate as a cooler/chiller of the products or the gasses in the porous material 20 at top dead center. The heat is rejected at relatively high temperatures, easing the implementation of heat exchangers. Under these conditions, the engine may need to be provided motive power, as the power into the gasses during the compression would be larger than the power produced by the gasses the power stroke (the expansion stroke). Alternatively, if the temperature of the porous material 20 is high (again, higher than the adiabative temperature of the gasses due to adiabatic compression of the gasses), then the power during the expansion (power) stroke would be larger than the power required during the compression, and the engine may generate some mechanical power. The engine may also generate mechanical power in the case that the reactions increase the number of moles, as this will result in increased pressure. Pressure increase due to exothermicity is limited by the substantial thermal mass of the porous material 20 (with or without a catalyst).

In the case that the engine required motive power to operate (when the exothermicity of the reaction is not sufficient to exceed friction), the engine could be motored using either a separate reciprocating engine or electric motor (see FIG. 7). For example, the pistons in the engine may be in communication with a crank shaft. This crank shaft may be rotated by a separate engine or motor, thereby causing the pistons to move within the respective cylinders. Alternatively, some cylinders in the same engine could be run stoichiometrically or any other means to generate power, or under any other suitable combustion conditions, to generate motoring power, while other cylinders in the engine can be run for driving the endothermic reaction. This system requires separate inlet and exhaust manifolds for the cylinders operating with different chemistries in the engine.

The inlet pressure can be high, as high as 10-20 bar or higher, if needed, limited by the structural components of the inlet manifold and the resulting peak pressure in the cylinder. The peak pressure in-cylinder can be as high as 200 bar or higher, depending on the structural components on the engine. Compression ratios as low as 4 and as high as 30 are possible for the engine reactors. The products can be at pressures higher than the inlet pressure, if desired (that is, the unit operates as a compressor, as well as a chemical reactor). It is possible that by adjusting the valve timing, the requirements for compressors (required to bring the pressure of the products to those that would be needed by reactors downstream, such as those for synthesis of methanol, FT diesel or ammonia) may be met. The manufacture of methanol, FT diesel and ammonia all require syngas, high pressures and mild temperatures. In the case of ammonia, in addition to hydrogen, nitrogen is also needed. The pressure in the inlet manifold can be high, as high as 10 bar or more, and the reagents may be also preheated (either separately or mixed together). In addition, the exhaust can be at high pressure by adjustment of the exhaust valve 52 timing. The exhaust valve 52 could either open early in what would be the power stroke of the engine (after top-dead-center when the reactions take place), or else, very late, during what would be the exhaust stroke. The later approach allows for additional time for reactions, if needed. However, it is clear that the valve opening has to clear the piston and the porous material.

The compression/expansion by the engine itself substantially reduces the need for a large compressor and the power required to drive the compressors (generally required for similar gas-phase processes), decreasing the size of the system and allowing for a self-sustained system (such as one that would be placed on a skid/pallet and moved to a remote site). A self-contained system, which is one that does not require external utilities for operation, would be desirable for mobile applications or where access to electric power is difficult or non-existent. In addition, the present technology allows the operation of compact systems, by reducing the cost of the reactor using highly developed, mass produced technologies (i.e., engines).

The same techniques described above for scavenging the compressed gas in the near-isothermal engine compressor with porous materials can be used in the catalytic engines. The scavenging fluid introduced into the catalytic engine reactor can be used for quenching also, if desired, depending on the timing of the injection. FIG. 4 shows injection of a liquid that vaporizes on the gas phase or on the porous material. The gases produced by the evaporation of the liquid drive the products out of the reactor, at pressure. In the case of catalytic engine reactors, the scavenging fluid may participate in the chemical reaction of subsequent cycles. For example, in the case of autothermal reforming, substantial amounts of water are required. Water introduced into the cylinder to scavenge the products of a given cycle may be used in the reaction of a subsequent cycle. In this case, there is no need to exhaust the scavenging fluid, as discussed in the case of the engine compressors (where it would be desirable to remove the scavenging fluid from the compressed gas).

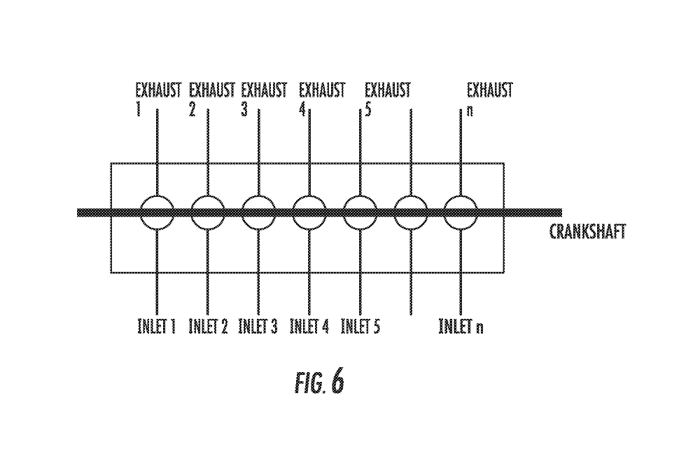

FIG. 6 shows a system with an engine with multiple cylinders. The pistons disposed in these cylinders may be in communication with a common crankshaft. The inlet manifolds and the exhaust manifolds can be separated, and the different cylinders can have different characteristics (for example, compression ratio, different composition and/or different inlet conditions and different porous materials and/or catalysts). Under those conditions, different inlet manifold and exhaust manifolds would be used for cylinders operating on different chemistry. Some of the cylinders (power producing cylinders) could be used for motoring the other cylinders containing the catalysts (power consuming cylinders). Not all cylinders need to have porous materials. Compressor cylinders, for example, could have porous material but no catalyst, while powering cylinders would be absent of porous material, and chemical reactors cylinders would have catalytic porous materials. Alternatively, different engines could be coupled either directly or through a gear box, with one engine producing power and the second engine used for reforming. An electric motor could replace the power producing engine, if electricity is available.

FIG. 7 shows a system for the generation of liquid fuels using a catalytic engine. The engine 100 can generate a limited amount of power due to the mild exothermicity of the reforming reaction because some of the cylinders are operating under different conditions (some power producing, some power consuming). The engine 100 receives reagents (hydrocarbon and an oxidizer, such as air, oxygen enriched air, or oxygen), either through the port or directly injected or both. A single exhaust is shown. Valves can be used to vary the productivity (throughput) through the engine. These valves are shown as being in the path of the exhaust, but also indicate the possibility of cylinder deactivation. The engine produces limited amount of power, extracted through the crankshaft. The crankshaft is connected to a gear box (which could be an automotive transmission) to adjust the speed of rotation. If needed, the oxygen separating unit (which could be an air separation engine as described herein) is driven directly by the motive power from the engine, such as the reciprocating machine. In addition, the reciprocating machine could be a compressor, with the output from the compressor going to the engine. Not shown in FIG. 7 is the possibility of using different exhaust manifolds (separate inlet manifolds are shown schematically in the Figure). Different chemistries could be used. For example, some of the cylinders could be operating in combustion mode to provide motive power, with their exhaust separate from the other cylinders. The syngas generated by the catalytic engine is conditioned in the gas cleanup unit. The gas cleanup unit is used for removal of excess water, for example, or sulfur and to adjust the temperature of the syngas for the fuel catalyst unit, which could be making methanol or FT diesel. Not shown are the potential reuse of unconverted gas from the fuel catalyst unit, which could be recycled either to the fuel catalyst unit or to the engine. The system could be coupled to an air separator unit, if needed. Electricity can be generated, or the motoring power can be used for driving reciprocating compressors. The system could be compact enough so that it can be placed on a flat bed trailer, a skid or a barge. The system could also be self-contained. The oxygen, if used in the reaction, can be produced either by the use of an air-separation unit, or through electrolysis, if only small amounts of oxygen are needed and there is excess power (as in the case of autothermal or near autothermal reforming).

One of the problems associated with using a catalytic engine for reforming is that replacement of the catalyst requires the disassembly of the engine. The engine needs to be modified in order to minimize the operations required for exchange the porous material. It may be possible, for example, to lower the engine crankcase while maintaining the cylinder head in a fixed position. This would require moving the crank shaft, but it minimizes the need to disconnect elements attached to the cylinder head, including the engine body. It is expected that because of the limited lifetime of the catalyst, it may be necessary to replace it on a time scale that is shorter than the lifetime of the engine (or when the engine requires rebuilding). On the other hand, the cost of the engines is sufficiently low that it may be possible to dispose of the engine after the catalyst fails. Lifetime of the catalyst may be about 1 year, corresponding to about 9,000 hours of engine operation (the equivalent of over 500,000 miles, if driven at 60 mph), however it could be longer or shorter.

It may be possible to reactivate the catalytic foam by periodically placing a liquid, gaseous or dispersed solids mixture in the cylinder which, when the reaction takes place, deposits a desired catalyst/washcoat on the porous material 20. The deposition could occur continuously, as is the case with the use of fuel-borne catalysts (such as ceria catalyst for soot oxidation which is introduced with diesel fuel, with the catalyst deposited downstream from the engine on the Diesel Particulate Filter). In the case of the engine-catalyst, the catalyst would deposit on the walls of the porous material 20, in a continuous (or semicontinuous fashion). The cylinder atmosphere during the catalyst reconditioning can be adjusted to attain the desired results. In another embodiment, subjecting the catalysts to introduction of specific compounds, specific temperatures alone, or modifying in-cylinder conditions, for a certain period of time may be sufficient to regenerate the catalyst or to deposit fresh catalyst.

Oil contamination of the catalyst can be prevented by changing the formulation of the lubricant, and by keeping it at a minimum, and by operating the cylinders at pressures higher than the pressure in the crankcase.

Although the description applies to fuel rich operation, it is possible to also use the catalyst for controlling ignition in engines operating in HCCI mode, with composition closer to conventional combustion. The porous material 20 or catalyst would be located close the wall to minimize the temperature during the combustion. Global ignition would be initiated by sufficient conversion of the air/fuel mixture on the catalyst, which can be controlled by adjusting conditions on the cylinder and catalyst choice and loading.

Many reactions may be carried out using catalytic engines. For example, for ammonia manufacturing (which requires hydrogen and nitrogen, at high pressure and modest temperature), with the porous material 20 controlling the temperature, the system would require high inlet manifold pressures in order to achieve the required pressures near top-dead center for conversion. In another example, ethane cracking (for the conversion of ethane into ethylene, which requires high temperature and mild pressures) requires fast heating/cooling of the gases, relatively low temperatures, and could also be done in such an engine, with relatively high temperatures in the inlet manifold to achieve the temperatures required for the process (800 K-1200 K) (without combustion). The ethane can be nearly pure ethane or it can be diluted, the dilution to improve performance, such as avoiding coking. The dilutant can be methane, water, CO₂, H₂ or others. The reaction is endothermic, so that power needs to be provided to the engine. The compression work to the gas could provide a substantial fraction of the required power, minimizing the requirement of heat transfer through walls. Additionally, the porous material 20 can be heated through external sources, such as electrical or electromagnetically (RF or infrared). Alternatively, the power can be provided by altering the chemistry in the cylinder, using exothermic reactions periodically to raise the temperature of the porous material 20 to the desired temperature (that is, one or more cycles using an exothermic reaction, provides some of the endothermic energy to drive the ethane cracking reaction in following cycles). One approach is simply to add an oxidizer in a few cycles. Alternatively, the oxidizer can be added continuously or as needed. The oxidizer can be premixed with the ethane inlet or it can be introduced directly into the engine through an injector, with the mixing occurring in the cylinder. Both catalytic and non-catalytic ethane cracking can be achieved in the engine with the porous material. If coking occurs, it could be cleaned by the periodic use of an oxidizer (either regular periods or else when needed). The engine compression ratio can be adjusted to provide the required energy to the reaction. Compression ratios from 10-30 are preferred. Because it is not needed to transfer heat through a surface, and the reactions occur in an engine that is capable of operating at very high pressures, the process is safer than the conventional process with a reactor/heat exchanger. Productivity can be increased by operating at elevated pressures. Coke formed during the process can be eliminated by periodic introduction of an oxidizer.

Some reactions are reversible, and the products may decompose during the expansion part of the cycle. Other reactions will optimize the desired product at some time, with selectivity or conversion decreasing after a particular optimal time in the engine cycle. For those reactions, conversion or selectivity can be improved by quenching. In the case of the engine, quenching can be achieved by introducing a cold reagent, preferably liquid, at or near the optimal time during the cycle. The cold reagent can be water, a hydrocarbon fluid, or a CFC (chlorofluorocarbon), or any other liquid.

In the case of steam reforming of natural gas, preliminary calculations indicate that compression heating of the methane/steam is not strong enough to provide the endothermicity required for the reaction. Large pre-heat of the steam/methane mixture may be required. Calculations indicate that with a compression ratio of 20, and preheat of the reagents to about 1000 K, with 4 bar inlet manifold pressure, hydrogen in the outlet can be as high as 25%. Increasing the preheat to 1300 K, hydrogen concentration (molar) in the outlet can be as high as 40%. Those levels of heating are high, but comparable to exhaust temperatures in the case of high torque, stoichiometric SI operation (as high as 1200 K). The methane conversion may not go through completion (defined as conversion higher than 90%); part of the problem is the required energy to drive the endothermic reaction, rather than the temperatures. For example, in the above calculations, with an inlet at 800 K, the peak temperature (adiabatic) increases to about 1050 K (with limited conversion). However, at 1300 K inlet temperature, the temperature at peak pressure is ˜1200 K, i.e., the temperature has actually decreased from that at the inlet (due to the endothermicity of the reaction), but with higher conversion. These calculations were performed using the CHEMKIN program, and the GRI 3.0 chemical kinetics mechanisms, by arbitrarily increasing homogeneous reactions by a factor of 20 or 40. Little sensitivity of the results was obtained by the change in the reaction rate multiplier, confirming that it is energy availability rather than kinetics that dominate the conversion. Thus, additional heat is needed. One way to do this is to provide a limited amount of oxygen, either as air or as oxygen enriched air (i.e., moving towards autothermal reforming), or as hydrogen peroxide. If there is extra energy at the site, it may be able to produce the peroxide in-situ.

In addition to making syngas, the system can be used for making fuels, methanol or FT diesel, or ammonia. The process is very attractive in that it is cyclic, with high pressures/temperatures during a short time, and recovery of the energy introduced into the system during the expansion process. This feature is very interesting in the case that the product needs to be removed from the mixture for multiple recycling of the reagents. Thus, after one compression/expansion cycle, the cold reagents can be extracted from the cylinder, further cooled in a recuperator (or any other type of heat exchanger), with the desired products condensed, and the unconverted reagents reheated in the recuperator (or any other type of heat exchanger) and then reintroduced into the engine. The fact that the reciprocating engine further heats and the cools the gases is very attractive for systems that require multiple passes/recirculation.

In the case of methanol and Fischer-Tropsch (FT), the reaction is exothermic. It is possible to recover some of the energy released in the reaction as mechanical power in the engine. Preliminary calculations indicate that enough exothermicity exists to at least overcome the friction losses in the engine, and more may be available for generating mechanical power. The mechanical power can be used to drive compressors, air separator units, peroxide generating units, etc, either directly or by generating electricity through a generator.

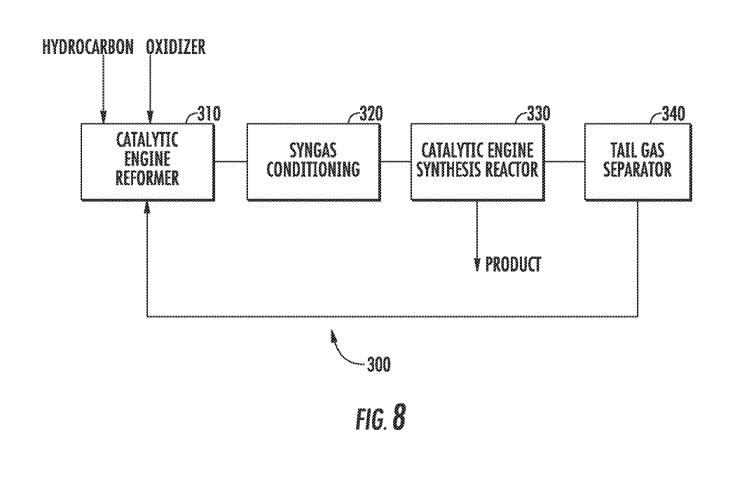

FIG. 8 shows an integrated plant 300 using both a syngas generator that uses a catalytic engine reformer 310 and a product synthesis reactor that uses a separate catalytic engine reactor 330. The engines do the compression, not needing much of a compressor (with the exception of compression needed for the reagents in the inlet (the hydrocarbon and the oxidizer, but even then, near-isothermal engine-compressors with porous materials could be used). The syngas conditioner 320 can be used for controlling the contamination going to the catalytic synthesis reactor (for example, sulfur, or dropping some excess water). The hydrocarbon can be natural gas, methane, ethane or other hydrocarbons, while the oxidizer can be air, oxygen, water, CO₂ or their mixture. The engine synthesis reactor can have substantial recycle, with some tail gas. Compounds from the tail gas (for example, hydrogen, with or without a water-shift reactor) can be separated from the tail gas using a separator 340 and re-introduced into the first reactor 310. FIG. 8 is not meant to be exclusive of other configurations. For example, a conventional syngas generator can be used, or an engine-based reformer (without a catalyst or porous material in the cylinder) as the first reactor. Alternatively, a conventional synthesis reactor can be used downstream from a catalytic engine reformer.

The different engines in FIG. 8 can be of different size (cylinder size, number of cylinders) and operating conditions (inlet temperature/pressure).

In principle, it is possible to use a single engine to do the two or three steps required: reforming, conditioning and synthesis. It is possible to provide different cylinder size and compression ratio, as well as different inlet manifolds and exhaust manifolds, for the single-engine plant.

The engine size can be as small as 1 liter, or as large as 20-50 liters. Multiple engines can be used, providing improved reliability/redundancy. Each engine can be doing more than one function, or different engines could be doing different functions. In the case of multiple engines that are operating at different engine speeds, conventional automotive components (e.g., transmissions) can be used to couple the different engines.

In the case of methanol, the products are in gaseous forms. The methanol needs to be removed from the syngas through a heat exchanger, which could be a self-regenerator. In the heat exchanger, the engine exhaust is cooled, the methanol then condenses downstream of the engine in a recuperator. In the case of Fischer Tropsch, the product fuel is a viscous liquid deposited in the catalyst. It is necessary to remove the liquid. This can be done by using a catalyst that is disposed next to the exhaust valve, the catalyst being between the piston and the exhaust valve. During the exhaust process, the gas has to flow out of the engine through the catalyst, at velocities determined by the piston motion and the exhaust valve opening. During the flow of the gas through the catalytic bed, the liquid can be removed. It may be preferable to orient the engine so that gravity helps in the process.

The porous material 20 on which the catalyst is deposited may be placed in the engine cylinder for ease of removal. For example, if the compression ratio of the engine is increased, and the injector/spark plug removed and replaced with a plug with a catalyst, the catalyst should be easily accessible for removal and replacement, without the need of removing the cylinder head. Although in some cases, it may be necessary to remove the cylinder head, or otherwise disassemble the engine. Alternatively, the pistons, cam shaft and connecting rods can be removed from the engine, without the need to disconnect the cylinder head from the engine body. The engine may be a conventional spark ignited or compression ignition engine and may be operated in any number of strokes, such as 2-stroke, 4-stroke, or 6-stroke, or even higher strokes per cycle engine, for example.

In another embodiment, a catalyst, disposed on a porous material in the cylinder, may be used to reduce emissions from the engine, when the engine is operated in a conventional manner with the objective of producing power. The engine may be fueled by gasoline, diesel fuel, alcohol or a combination thereof. In one embodiment, the catalyst may be used to reduce cold start emissions. The emissions that are reduced may be regulated and unregulated emissions and may include CO, HC, NOₓ, and other species. In another embodiment, the catalyst may be used to generate products that are beneficial for the operation of the emissions aftertreatment systems, such as hydrogen, or ammonia in one example. In another embodiment, the emissions may not be reduced, but are rather stored for a period of time before being released, such as in low temperature traps.

In another embodiment, the catalyst or porous material are used to enhance, support, or stabilize the combustion process. The combustion process may be conventional gasoline or diesel combustion or employ an advanced combustion strategy such as homogeneous charge compression ignition (HCCI) or some other low temperature combustion mode (LTC) or a derivative thereof. The catalyst or foam may influence ignition delay, ignition quality, flame propagation in the cylinder, the rate of heat release, and other parameters controlling the combustion process. The catalyst or foam may enhance fuel consumption or combustion efficiency.

Many reactions, both endothermic and exothermic, could be driven in the engine catalytic reactor. The engine catalyst could be very attractive for driving reactions that require very high pressures and/or high temperatures, that are difficult to achieve in conventional reactors. While methane reforming is described, there are other reactions that could also benefit from this approach, such as hydrocarbon reforming, ammonia or methanol manufacturing.

Ethane cracking may be allowable by the high pressure, relatively high temperatures of the cylinder. The ethane cracking reaction is highly endothermic, so the cylinders need to be driven externally. Coke can be handled by the regeneration process described above, with an oxidizer. In addition, polyethylene can also be manufactured in the reactor.

Although internal combustion engines are described, many other types of piston and cylinder assemblies are possible, including opposed piston systems and others, which may not necessarily form a fully-functional engine. Further, rotary systems, such as wankel type engines in one example, and other rotary systems may also be used.

While particular embodiments have been shown and described, it will be obvious to those skilled in the art that various changes and modifications may be made without departing from the disclosure in its broader aspects. It is intended that all matter contained in the above description and shown in the accompanying drawings shall be interpreted as illustrative and not in a limiting sense.

What is claimed is:

1. An engine comprising:
a cylinder comprising:
a top surface,
a reciprocating piston,
a porous material and a catalyst, wherein each is disposed between the piston and the top surface.

2. The engine of claim 1, wherein the catalyst is disposed on the porous material.

3. The engine of claim 1, wherein the catalyst is disposed on a wall of the cylinder, on the piston or on a top surface of the cylinder.

4. The engine of claim 2, wherein a catalyst in a first region of the porous material is different than a catalyst in a second region.

5. The engine of claim 1, wherein the porous material is disposed on the top surface, and a thermal insulator is disposed between the top surface and the porous material.

6. An engine comprising:
a cylinder comprising:
a top surface,
a reciprocating piston,
a porous material comprising a gas adsorber, wherein the porous material is disposed between the piston and the top surface.

7. The engine of claim 6, wherein the gas adsorber preferentially adsorbs one constituent of a gas introduced into the cylinder.

8. The engine of claim 7, wherein the gas introduced into the cylinder is separated into two or more gasses.

9. A method of processing a gas, comprising:
introducing a gas into a cylinder having a reciprocating piston, a porous material and a catalyst disposed in the cylinder between a top surface and the piston; and
moving the piston in the cylinder to as to compress the gas, where the catalyst causes a chemical reaction with the gas during the compression.

10. The method of claim 9, wherein the catalyst is disposed on the porous material.

11. The method of claim 10, further comprising controlling a temperature of the porous material.

12. The method of claim 9, further comprising:
exhausting the gas after the compression;
introducing a second gas into the cylinder after the exhausting, wherein the second gas reacts with products of the chemical reaction of the gas that have been left in the cylinder.

13. The method of claim 12, wherein the products comprise soot and the second gas comprises an oxidizer.

14. The method of claim 12, wherein the gas is introduced into the cylinder through a first intake valve and the second gas is introduced into the cylinder through a second intake valve.

15. The method of claim 12, wherein the gas is introduced into the cylinder through a first intake valve and the second gas is introduced into the cylinder through an injector.

16. The method of claim 12, wherein the gas is exhausted from the cylinder through a first exhaust valve and the second gas is exhausted from the cylinder through a second exhaust valve.

17. The method of claim 9, wherein the gas is introduced through an inlet valve and a second gas is introduced through a different inlet valve, and mixing of the gasses occurs in the cylinder.

18. The method of claim 9, wherein the gas is introduced through an inlet valve and a second gas is introduced through an injector, and mixing of the gasses occurs in the cylinder.

19. The method of claim 9, further comprising performing other chemical reactions in the cylinder during other engine cycles in order to recondition the catalyst.

20. The method of claim 19, wherein a temperature of the catalyst is changed by the other chemical reactions.

21. The method of claim 19, wherein the catalyst is reduced or oxidized by the other chemical reactions.

22. The method of claim 9, wherein the gas comprises methane or ethane and the chemical reaction comprises catalytic partial oxidation or catalytic autothermal reforming using steam or CO₂, thereby creating H₂ and CO.

23. A method of producing syngas, comprising:
introducing a gas into a cylinder having a reciprocating piston, a porous material and a catalyst disposed in the cylinder between a top surface and the piston, where the gas is a hydrocarbon;
introducing a second gas into the cylinder, the second gas being an oxidizer;
introducing CO₂ or H₂O into the cylinder; and
moving the piston in the cylinder to as to compress the gas, where the catalyst causes a chemical reaction between the gas and the second gas during the compression, thereby producing syngas.

24. The method of claim 23, wherein the piston is in communication with a crank shaft and a separate engine is used to rotate the crank shaft, thereby causing the piston to move in the cylinder.

25. The method of claim 23, wherein cylinder is part of an engine having an additional cylinder, and wherein the piston is in communication with a crank shaft and an additional piston disposed in the additional cylinder is in communication with the crank shaft, whereby the additional cylinder operates in a power generating mode and the additional piston rotates the crank shaft.

26. A method of operating an engine, comprising:
providing an engine having a plurality of cylinders, each having a reciprocating piston disposed therein, where a porous material disposed in each of the cylinders and a catalyst disposed on the porous material;
introducing a fuel into the plurality of cylinders;
combusting the fuel in the cylinders; and
exhausting the combusted fuel from the cylinders, wherein the catalyst is selected to modify the composition of the exhausted fuel.

27. The method of claim 26, wherein the catalyst reduces cold start emissions.

28. The method of claim 26, wherein the catalyst produces products used by an emission aftertreatment system.

29. The method of claim 28, where the product comprises hydrogen or ammonia.

30. A method of operating an engine, comprising:
providing an engine having a plurality of cylinders, each having a reciprocating piston disposed therein, where a porous material disposed in each of the cylinders and a catalyst disposed on the porous material;
introducing a fuel into the plurality of cylinders;
combusting the fuel in the cylinders; and
exhausting the combusted fuel from the cylinders, wherein the catalyst is selected to stabilize the combustion process.
